(19) United States
(12) Patent Application Publication
(10) Pub. No.: US 2014/0312247 A1
(43) Pub. Date: Oct. 23, 2014

(54) FLUORESCENCE IMAGER ON A MOBILE DEVICE

(71) Applicant: Bio-Rad Laboratories, Inc., Hercules, CA (US)

(72) Inventors: Clayton T. McKee, Davis, CA (US); William Strong, EI Cerrito, CA (US); Neeraj Bhatt, Hercules, CA (US)

(73) Assignee: Bio-Rad Laboratories, Inc., Hercules, CA (US)

(21) Appl. No.: 14/252,406

(22) Filed: Apr. 14, 2014

Related U.S. Application Data
(60) Provisional application No. 61/813,457, filed on Apr. 18, 2013.

(51) Int. Cl. G01N 21/64

(52) U.S. Cl. CPC G01N 21/6428
USPC 250/459.1; 250/458.1; 250/208.1

(57) ABSTRACT

Systems and methods for substantially simultaneously exciting a fluorescently labeled specimen and capturing fluorescent light emitted therefrom using a smartphone, tablet, or similar mobile computing device, are disclosed herein. The system includes a light-emitting diode (“LED”) light source coupled with the smartphone to excite the specimen and an imaging device coupled with the smartphone to capture fluorescent light emitted from the specimen. The system further includes a hood adapted to be coupled with the smartphone that has an excitation filter configured to produce a first wavelength of electromagnetic radiation to strike the specimen when light from the LED light source passes through it and an emission filter configured to receive the light emitted from the specimen and to produce a second wavelength of electromagnetic radiation to be captured by the imaging device.

### CROSS-REFERENCES TO RELATED APPLICATIONS

This application claims the benefit of Provisional Application No. 61/813,457, filed Apr. 18, 2013, entitled “Fluorescence Imager On a Mobile Device,” the disclosure of which is hereby incorporated herein by reference.

### BACKGROUND OF THE INVENTION

The techniques described herein relate generally to biological imaging systems. More specifically, the techniques described herein relate to fluorescence imaging techniques using a mobile device.

### BRIEF SUMMARY OF THE INVENTION

According to certain embodiments, a method is provided for substantially simultaneously exciting a fluorescently labeled specimen and capturing fluorescent light emitted therefrom using a smartphone, tablet computer, mobile computer, or other similar device. The specimen can be excited using a light-emitting diode (“LED”) light source coupled with the smartphone and the fluorescent light emitted from the specimen can be captured using an imaging device coupled with the smartphone. Embodiments also include a hood device adapted to be coupled with the smartphone that has an excitation filter and an emission filter. The excitation filter can be adapted to produce a first wavelength of electromagnetic radiation to strike the specimen when light from the LED light source passes through it and the emission filter can be adapted to receive the fluorescent light emitted from the specimen and produce a second wavelength of electromagnetic radiation to be captured by the imaging device. In one embodiment, the second wavelength of electromagnetic radiation can be in the visible light spectrum for observation by users. In another embodiment, the second wavelength of electromagnetic radiation can be in the infrared (“IR”) spectrum. The specimen can then be detected based on the light captured by the imaging device.

Both the LED light source and the imaging device can be powered and controlled by the smartphone. In at least certain embodiments, the fluorescence of the specimen can be excited by a white light LED light source from the smartphone's flash or by a LED light source separate from the smartphone that is powered and controlled by the smartphone via a wired or wireless connection. Likewise, the emitted fluorescent light can be captured directly via the camera built into the smartphone or by an imaging device powered and controlled by the smartphone via a wired or wireless connection. The hood device can be configured to attach to the smartphone and includes at least two open apertures including (1) a first aperture for positioning the excitation filter over the front of the LED light source of the smartphone and (2) a second aperture for positioning the emission filter over the front of the lens of the imaging device of the smartphone. The hood device can also be designed to allow users to interchange the excitation and emission filters for use with different fluorophores. In some embodiments that hood may have multiple filters for either excitation, emission, or both, thereby allowing selection of the filters by users during operation.

In yet other embodiments, a system is provided for substantially simultaneously exciting a fluorescently labeled specimen and capturing fluorescent light emitted therefrom using a smartphone. The system in such an embodiment includes a LED light source coupled with the smartphone to excite the specimen and an imaging device coupled with the smartphone to capture fluorescent light emitted from the specimen. This embodiment also can include a hood adapted to be coupled with the smartphone. The hood includes (1) an excitation filter configured to produce a first wavelength of electromagnetic radiation to impact the specimen when light from the LED light source passes through it and (2) an emission filter configured to receive the light emitted from the specimen and to produce a second wavelength of electromagnetic radiation to be captured by the imaging device. The second wavelength of electromagnetic radiation can be in the visible light spectrum so that the specimen can be detected based on the light captured by the imaging device. In another embodiment, the second wavelength of electromagnetic radiation can be in the infrared spectrum.

These and other embodiments along with many of their advantages and features are described in more detail in conjunction with the following description, claims, and figures.

### BRIEF DESCRIPTION OF THE DRAWINGS

A better understanding of at least certain embodiments of the invention can be obtained from the following detailed description in conjunction with the following drawings, in which:

FIG. 1 depicts an example block diagram of a system for capturing fluorescent light emitted from a specimen using a smartphone according to one embodiment.

FIG. 2 depicts a display showing results of capturing fluorescent light emitted from a specimen using a smartphone according to one embodiment.

FIG. 3 depicts an example block diagram of a system for capturing fluorescent light emitted from a specimen using a smartphone according to an alternative embodiment.

FIG. 4 depicts a set of displays comparing results obtained via a smartphone with results obtained from a specialized imaging system.

FIG. 5 depicts an example flow chart of a process for capturing fluorescent light emitted from a specimen using a smartphone according to one embodiment.

FIG. 6 depicts an example block diagram of a data processing system upon which the disclosed embodiments may be implemented.

### DETAILED DESCRIPTION OF THE INVENTION

Throughout this description for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the described embodiments.

The systems and methods introduced herein are adapted to substantially simultaneously excite a fluorescently labeled specimen and capture fluorescent light emitted therefrom using a device such as a smartphone, tablet computer, mobile computer, or other similar device. Reference is made herein to using a smartphone. It is understood that the smartphone is referenced as an exemplary device and that embodiments of the invention are not limited to using a smartphone.

“Fluorescence” is the emission of visible or invisible radiation produced from certain substances as a result of absorbing incident electromagnetic radiation of a (generally) shorter wavelength such as x-rays or ultraviolet light. It is the property of absorbing light of shorter wavelength and emitting light of a longer one. In most cases, the emitted light has a longer wavelength, and therefore lower energy, than the absorbed radiation. The most striking examples of fluorescence occur when the absorbed radiation is in the ultraviolet region of the spectrum, and thus invisible to the human eye, and the emitted light is in the visible region of the spectrum and can be perceived by humans.

In one embodiment, the specimen is a fluorescently labeled protein (e.g., a labeled antibody). The specimen can be excited using a LED light source coupled with the smartphone and the fluorescent light emitted from the specimen can be captured using an imaging device coupled with the smartphone. Fluorescent labeling is the process of covalently attaching a “fluorophore” to another molecule, such as a protein or nucleic acid. A fluorophore (or fluorochrome) is a fluorescent chemical compound that can re-emit light upon excitation. Fluorophores typically contain several combined aromatic groups, or plane or cyclic molecules with several π bonds. Fluorophores are sometimes used alone, as a tracer in fluids, as a dye for staining of certain structures, as a substrate of enzymes, or as a probe or indicator (when its fluorescence is affected by environment such as polarity, ions, etc.). But more generally fluorophores are covalently bonded to a macromolecule, serving as a marker (e.g., dye, tag, or reporter) for bioactive reagents (e.g., antibodies, peptides, nucleic acids). Fluorophores are notably used to stain tissues, cells, or materials in a variety of analytical methods, such as fluorescent imaging and spectroscopy.

Fluorescent labeling is generally accomplished using a reactive derivative of the fluorophore that selectively binds to a functional group contained in the target molecule. The most commonly labeled molecules are antibodies, proteins, amino acids and peptides which are then used as specific probes for detection of a particular target. Fluorescent labels are generally used for detection of a protein or other labeled molecule via a fluorescence microscope, flow cytometer or some other fluorescence reading instrument. These can be useful in localization of a target within a cell, flow cytometry (FACS) analysis, western blot assays, and other immunoanalytical methods.

In some embodiments, the LED light source is coupled with the smartphone (as part of the smartphone or physically separate from the smartphone) and under the control of the smartphone. Other similar mobile computing devices can also be used such a tablet or mobile computer, etc. The light source can either be a LED contained within the smartphone (e.g., the white light LED that is used for flash on the smartphone), or it can be a LED (Red, Green, or Blue) that is directly powered by the smartphone battery and controlled via a data or power cable attached to the smartphone. Alternatively, the light source (still considered “coupled with”) can be separate from, and under the control of the smartphone. For instance, the light source can be an LED (Red, Green, or Blue) that is controlled by the smartphone via a Bluetooth connection and powered separately. The emitted fluorescent light from the specimen can then be captured directly via the smartphone camera system or by a camera system that is controlled and powered by the smartphone.

The camera system can be powered and controlled using a data/power cable attached to the smartphone or by a camera system that is controlled by the smartphone via a Bluetooth connection and powered separately. For instance, such a technique can be used to avoid a problem that occurs whereby many modern mobile devices include imaging devices that automatically filter out infrared light to improve picture quality. The embodiments described herein are not limited to any particular type of wired or wireless network connection. In addition, the coupling of the LED with the smartphone can be a direct connection or a functional connection. In one embodiment, there may be one or more intermediate components coupled between the smartphone and the LED.

The LED light source of the smartphone can be used for excitation of these fluorescently labeled proteins that have been captured on a membrane. In some embodiments, the membrane can typically be of polyvinylidene fluoride (“PVDF”) or nitrocellulose. The proteins (or nucleic acids) in the specimen can be transferred to the membrane where they can be stained with fluorescently-labeled antibodies specific to the target protein. Polyvinylidene fluoride (or polyvinylidene difluoride) is a highly non-reactive thermoplastic fluoropolymer produced by the polymerization of vinylidene difluoride. A fluoropolymer is a fluorocarbon based polymer with multiple strong carbon-fluorine bonds. It is characterized by a high resistance to solvents, acids, and bases. PVDF is a specialty plastic material in the fluoropolymer family; it is used generally in applications requiring the highest purity, strength, and resistance to solvents, acids, and bases. Other embodiments are adapted to be used in conjunction with microplates, microscope slides, microarrays, or other materials commonly used with fluorescent detection in biochemistry.

Embodiments can also include a “hood” adapted to be coupled with the smartphone that has an excitation filter and an emission filter. The excitation filter can be adapted to produce a first wavelength of electromagnetic radiation to strike the specimen when light from the LED light source passes through the excitation filter and the emission filter can be adapted to receive the fluorescent light emitted from the specimen and produce a second wavelength of electromagnetic radiation to be captured by the imaging device. In one embodiment, the second wavelength of electromagnetic radiation is in the visible light spectrum for observation by users. The specimen can then be detected based on the light captured by the imaging device. In another embodiment, the second wavelength of electromagnetic radiation is in the infrared spectrum. Using emitted infrared light can be advantageous because there are no known naturally occurring fluorescent materials in biological specimens that emit light in the infrared spectrum when excited. It may be desirable in certain applications to image the emitted infrared light instead of visible light to reduce any spurious or false-positive signals that may be emitted from a particular specimen in the visible light spectrum.

In the case where fluorescence and detection are carried out via the white light LED and camera directly attached to the smartphone, the hood can be provided that is designed to be attached over the smartphone. In one embodiment, the hood is designed to have two open apertures which allow for the insertion of the excitation and emission filters respectively to control the wavelength of light striking the fluorophore and the wavelength of the emitted light that reaches the image sensor of the camera. The hood can be designed such that it snaps into place over the smartphone in such a way that the aperture for the excitation filter is positioned over the front of the LED light source of the smartphone and the aperture for the emission filter is positioned over the front of the lens of the smartphone camera. Other ways of coupling the hood device with the smartphone can also be used and the embodiments described herein are not intended to be limited by any particular mechanism for attaching the hood device to the smartphone.

In addition, the hood can also be designed to easily interchange the excitation and emission filters for various fluorophores. In some embodiments the hood may have multiple filters for either excitation, emission, or both, thereby allowing selection of the filters to be used during operation. For example, multiple filters may be built-into a rotating wheel (or wheels) that allows different filters to be selected by users and are disposed such that each filter can be rotated into place for performing the operations described herein. In addition, if the camera within the smartphone or tablet computer does not have a built-in filter to remove infrared light it may be possible to detect this IR radiation with the appropriate emission filter. Many devices include a built-in filter for IR radiation to improve picture quality.

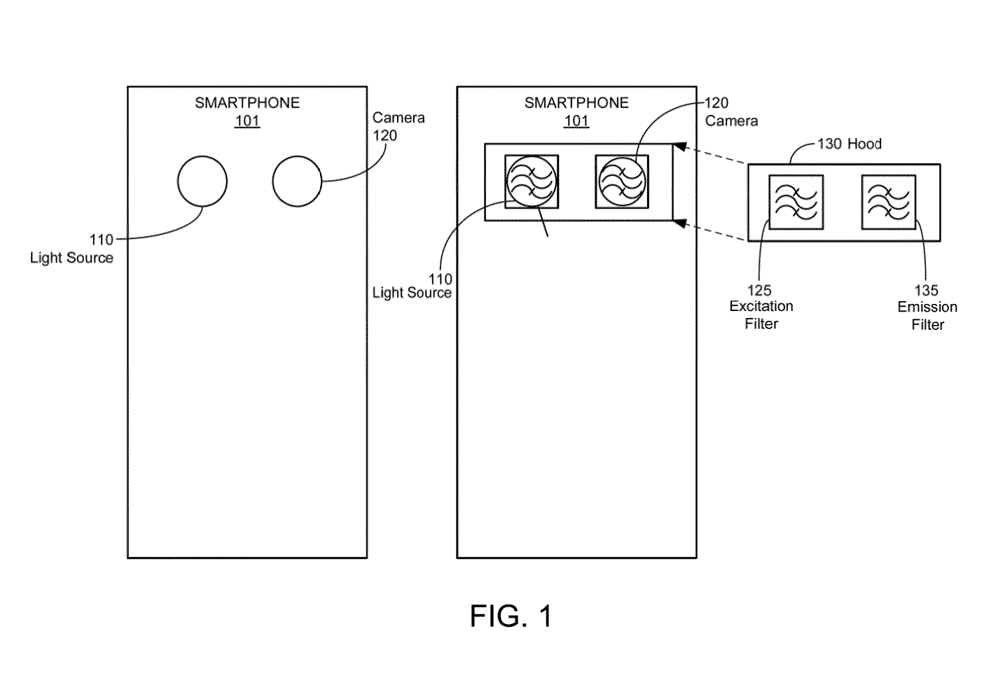

An example block diagram of the hood coupled with a smartphone is shown in FIG. 1, which depicts one embodiment of a system for capturing fluorescent light emitted from a specimen using a smartphone. In the illustrated embodiment of FIG. 1, smartphone 101 includes a light source 110 and a camera 120. A hood 130 is also provided that includes an excitation filter 125 and an emission filter 135. The hood 130 can be adapted to couple with the smartphone 101 as shown, and can be designed to be positioned such that the excitation filter is placed in front of the light source 110 and the emission filter is placed in front of the camera 120 of the smartphone 101. The excitation filter 125 can be adapted to filter the light passing through it from the light source 110 to produce a first wavelength of electromagnetic radiation to strike the specimen. Various excitation filters 125 can be used for exciting different specimen types as is well known in the art. The emission filter 135 can be adapted to filter the light passing through it from the light emitted or reflected from the specimen to produce a second wavelength of electromagnetic radiation to be captured by the camera 120 or other imaging device coupled with the smartphone 101. Various emission filters 125 can also be used for different specimen types.

In one embodiment, the “Western Blot” technique can be used for detecting the specimen. Western Blot (sometimes called the protein immunoblot) is a widely accepted analytical technique used to detect specific proteins in the given sample of tissue. It uses gel electrophoresis to separate native proteins by 3-D structure or denatured proteins by the length of the polypeptide. In one embodiment, the method and system are adapted to analyze one or more proteins (or nucleic acid) present in a western blot (western blotting is generally described in, e.g, Sambrook et al. (Molecular Cloning: A Laboratory Manual; Cold Spring Harbor Laboratory, Cold Spring Harbor, N.Y., (1989); Current Protocols in Molecular Biology, Ausubel et al., Green Pub. Associates and Wiley-Interscience, New York (1988); Yeast Genetics: A Laboratory Course Manual, Rose et al., Cold Spring Harbor Laboratory, Cold Spring Harbor, N.Y., (1990)). The analysis of the specimen after the image has been captured can also be performed using an application running on the smartphone. The techniques disclosed herein are not limited to western blots as these techniques can be used in conjunction with a Southern blot and northern blot, etc.

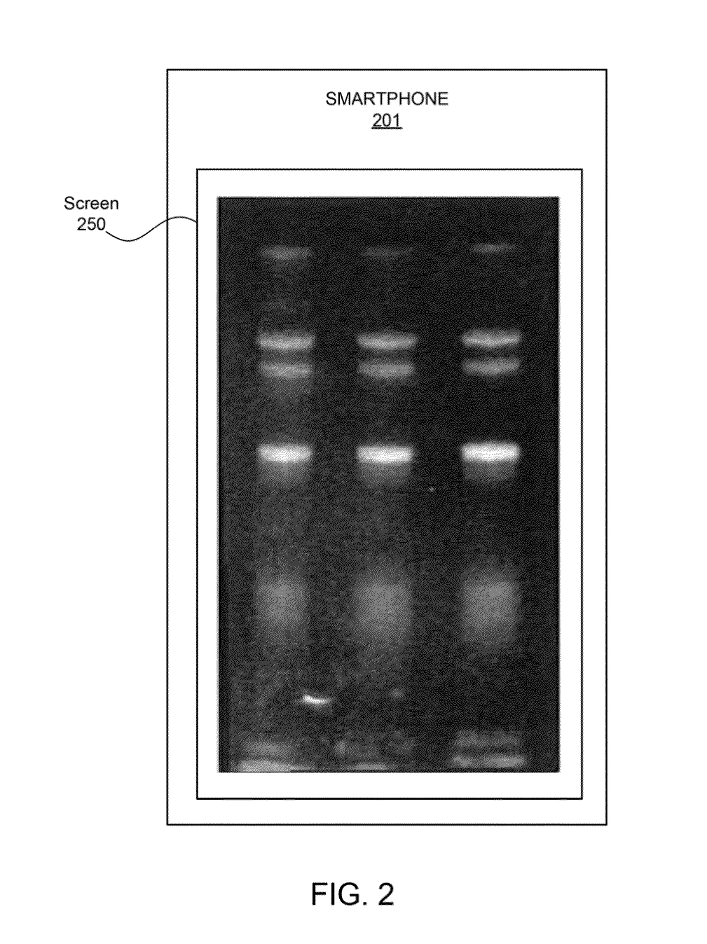

FIG. 2 depicts a display showing an example embodiment of the results of capturing fluorescent light emitted from a specimen using a smartphone. FIG. 2 includes smartphone 201 and its corresponding display screen 250. The illustrated embodiment shows the fluorescent response of Cy3 labeled proteins that are bound to a low fluorescent PVDF membrane. The fluorescence of the cyanine dye Cy3 was excited using a 535/30 nm excitation filter placed in front of the white LED of the smartphone. Cyanine is a non-systematic name of a synthetic dye family belonging to polymethine group. Cyanines are used in industry, more recently in biotechnology (labeling, analysis). Cyanines have many uses as fluorescent dyes, particularly in biomedical imaging. Depending on the structure, they cover the spectrum from infrared (“IR”) to ultraviolet (“UV”). The emission of fluorescent light from the Cy3 dye was collect by placing a 590/50 emission filter in front of the 8 megapixel camera of the smartphone. In this design, the gel can be imaged in any location that is protected from background illumination (e.g., a dark room, a box, etc.).

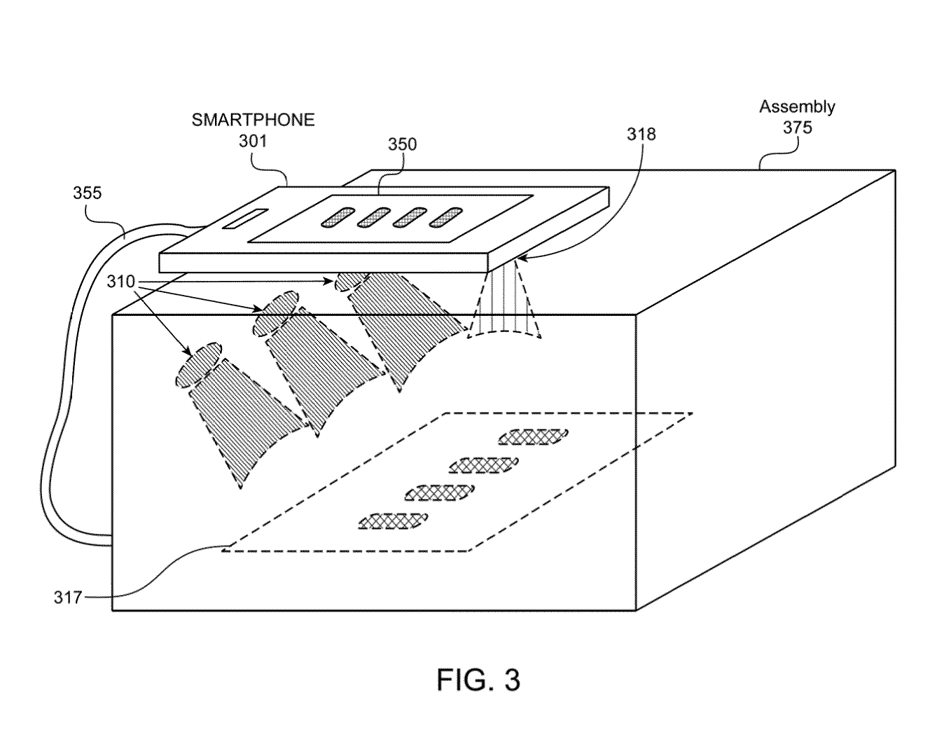

FIG. 3 depicts an example block diagram of a system for capturing fluorescent light emitted from a specimen using a smartphone according to an alternative embodiment. In this embodiment, the fluorescence excitation is controlled via LEDs 310 that are separate from the smartphone 301. A small container or assembly 375 can be provided with the LEDs 310 incorporated therein. These LEDs 310 can be powered either by the smartphone 301 itself, or by a separate power source (not shown). In the case of direct power via the smartphone 301, a data/power cable 355 can be provided to couple the smartphone with the LEDs 310 housed in the assembly 375. In the case the LEDs 310 are separately powered, the smartphone 301 can control the LEDs 310 via a wired or wireless connection. In the top of the assembly 375, a small aperture 318 can be positioned to allow the smartphone camera to image the fluorescent labeled proteins on a PVDF or nitrocellulose membrane 317 that has been placed at the base of the assembly 375. The LEDs 310 can excite the fluorophores and the camera of the smartphone 301 can substantially simultaneously capture the image of the emitted light. Emission filters can be interchangeable on the camera's imaging sensor position. The results of the image capture are then capable of being displayed on the display screen 350 of the smartphone 301. The imaging device can also be used for the detection of proteins via chemiluminescence, bioluminescence, or other luminescent detection systems.

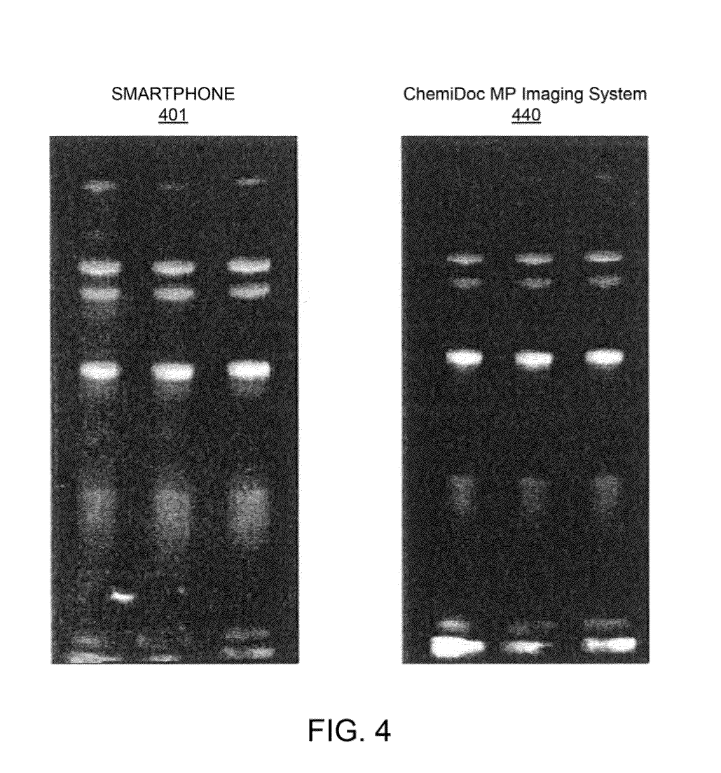

In at least certain embodiments, the specimen is a macro specimen that does not require a microscope to be incorporated into the system to obtain useable images of the specimen. In other embodiments, the specimen may be a micro-specimen and a microscope can be incorporated into the system. In all iterations of the device, software applications within the smartphone 301 can be provided to control the light sources 310 and the imaging sensor of the smartphone's camera during excitation and emission of the fluorescently labeled proteins. In addition, software can be written to further process, analyze, and transmit the collected data. The light emitted from the specimen 317 is collected by the camera thereby capturing an image of the fluorescent light. FIG. 4 depicts a set of displays comparing results obtained via a smartphone 401 with results obtained from a specialized imaging system 440, in this instance, a ChemiDoc MP Imaging System as is well known in the art.

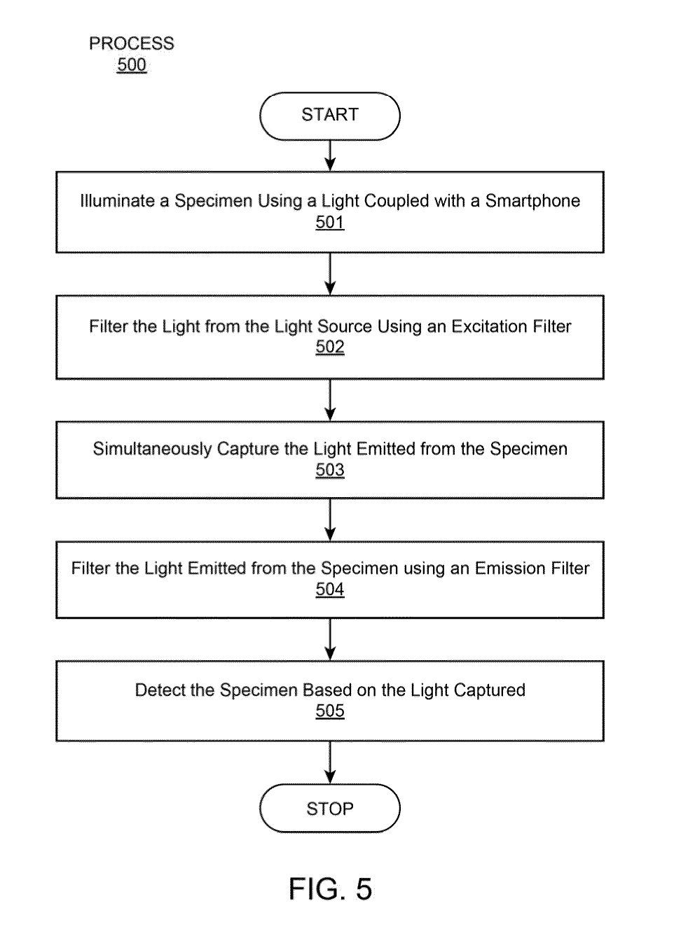

FIG. 5 depicts an example flow chart of a process for capturing fluorescent light emitted from a specimen using a smartphone according to one embodiment. In the illustrated embodiment, process 500 begins at operation 501 where a specimen is illuminated using light from a light source coupled with a smartphone. In one embodiment, the light source can be the LEDs of the smartphone's flash device. Process 500 continues at operation 502 where the light from the light source is filtered using an excitation filter that is adapted to produce a first wavelength of electromagnetic radiation to strike the specimen when light from the LED light source passes through it. As described above, the excitation filter can vary and can be chosen to match the particular specimen of interest. Process 500 continues at operation 503 where the light emitted from the specimen can then be substantially simultaneously captured using an imaging device coupled with the smartphone. In one embodiment, the imaging device is the imaging sensor of the smartphone's built in camera device. In other embodiments, the imaging device can be separate from the smartphone and controlled by the smartphone via a wired or wireless connection. In yet other embodiments, the imaging device can be controlled by the smartphone via a Bluetooth connection and powered separately.

The light emitted from the specimen is filtered using an emission filter adapted to receive the fluorescent light emitted from the specimen and produce a second wavelength of electromagnetic radiation to be captured by the imaging device (operation 504). In one embodiment, the second wavelength of electromagnetic radiation is in the visible light spectrum for observation by users. In another embodiment, the second wavelength of electromagnetic radiation is in the infrared spectrum. The specimen can then be detected based on the light captured by the imaging device (operation 505). This completes process 500 according to one example embodiment.

In addition, distortion characteristics of camera systems can be corrected via calibration or image processing. Such techniques have generally been disclosed in the following U.S. Patent Applications: (1) U.S. patent application Ser. No. 10/174,510 entitled “Flat Field Correction of Digital Images of Electrophoresis Gels by Use of Reference Illumination,” filed Jun. 17, 2002; (2) U.S. patent application Ser. No. 08/814,126 entitled “A Method and Apparatus for Correcting Illumination Non-Uniformities,” filed Mar. 10, 1997; and (3) U.S. patent application Ser. No. 12/791,795 entitled “Calibration of Imaging Device for Biological/Chemical Sample,” filed Jun. 1, 2010, each of which is incorporated into this application by reference in its entirety.

Provided below are descriptions of some devices (and components of those devices) that may be used in the systems and methods described above. These devices may be used, for instance, to receive, transmit, process, or store data related to any of the functionality described above. As will be appreciated by one of ordinary skill in the art, the devices described below may have only some of the components described below, or may have additional components.

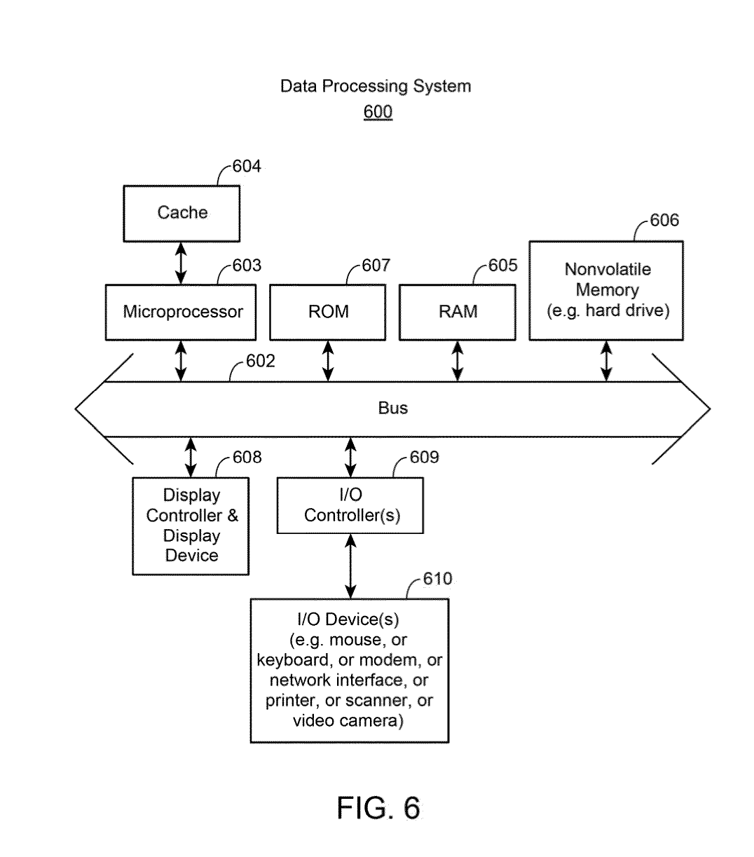

FIG. 6 depicts an example block diagram of a data processing system upon which the disclosed embodiments may be implemented. Embodiments of the present invention may be practiced with various computer system configurations such as hand-held devices, microprocessor systems, microprocessor-based or programmable user electronics, minicomputers, mainframe computers and the like. The embodiments can also be practiced in distributed computing environments where tasks are performed by remote processing devices that are linked through a wire-based or wireless network. FIG. 6 shows one example of a data processing system, such as data processing system 600, which may be used with the present described embodiments. Note that while FIG. 6 illustrates various components of a data processing system, it is not intended to represent any particular architecture or manner of interconnecting the components as such details are not germane to the techniques described herein. It will also be appreciated that network computers and other data processing systems which have fewer components or perhaps more components may also be used. The data processing system of FIG. 6 may, for example, be a personal computer (PC), workstation, tablet, smartphone or other hand-held wireless device, or any device having similar functionality.

As shown, the data processing system 600 includes a system bus 602 which is coupled to a microprocessor 603, a Read-Only Memory (ROM) 607, a volatile Random Access Memory (RAM) 605, as well as other nonvolatile memory 606. In the illustrated embodiment, microprocessor 603 is coupled to cache memory 604. System bus 602 can be adapted to interconnect these various components together and also interconnect components 603, 607, 605, and 606 to a display controller and display device 608, and to peripheral devices such as input/output (“I/O”) devices 610. Types of I/O devices can include keyboards, modems, network interfaces, printers, scanners, video cameras, or other devices well known in the art. Typically, I/O devices 610 are coupled to the system bus 602 through I/O controllers 609. In one embodiment the I/O controller 609 includes a Universal Serial Bus (“USB”) adapter for controlling USB peripherals or other type of bus adapter.

RAM 605 can be implemented as dynamic RAM (“DRAM”) which requires power continually in order to refresh or maintain the data in the memory. The other nonvolatile memory 606 can be a magnetic hard drive, magnetic optical drive, optical drive, DVD RAM, or other type of memory system that maintains data after power is removed from the system. While FIG. 6 shows that nonvolatile memory 606 as a local device coupled with the rest of the components in the data processing system, it will be appreciated by skilled artisans that the described techniques may use a nonvolatile memory remote from the system, such as a network storage device coupled with the data processing system through a network interface such as a modem or Ethernet interface (not shown).

It will be apparent from this description that aspects of the described techniques may be embodied, at least in part, in software, hardware, firmware, or any combination thereof. It should also be understood that embodiments can employ various computer-implemented functions involving data stored in a data processing system. That is, the techniques may be carried out in a computer or other data processing system in response executing sequences of instructions stored in memory. In various embodiments, hardwired circuitry may be used independently, or in combination with software instructions, to implement these techniques. For instance, the described functionality may be performed by specific hardware components containing hardwired logic for performing operations, or by any combination of custom hardware components and programmed computer components. The techniques described herein are not limited to any specific combination of hardware circuitry and software.

Embodiments herein may also be in the form of computer code stored on a computer-readable medium. Computer-readable media can also be adapted to store computer instructions, which when executed by a computer or other data processing system, such as data processing system 600, are adapted to cause the system to perform operations according to the techniques described herein. Computer-readable media can include any mechanism that stores information in a form accessible by a data processing device such as a computer, network device, tablet, smartphone, or any device having similar functionality. Examples of computer-readable media include any type of tangible article of manufacture capable of storing information thereon such as a hard drive, floppy disk, DVD, CD-ROM, magnetic-optical disk, ROM, RAM, EPROM, EEPROM, flash memory and equivalents thereto, a magnetic or optical card, or any type of media suitable for storing electronic data. Computer-readable media can also be distributed over a network-coupled computer system, which can be stored or executed in a distributed fashion.

Throughout the foregoing description, for the purposes of explanation, numerous specific details were set forth in order to provide a thorough understanding of the invention. It will be apparent, however, to persons skilled in the art that these embodiments may be practiced without some of these specific details. Accordingly, the scope and spirit of the invention should be judged in terms of the claims which follow as well as the legal equivalents thereof.

What is claimed is:

1. A method comprising:
upon input from a user, exciting a fluorescently labeled specimen and substantially simultaneously capturing fluorescent light emitted therefrom using a mobile device, wherein the specimen is excited using a light-emitting diode (“LED”) light source coupled with the mobile device and the fluorescent light emitted from the specimen is captured using an imaging device coupled with the mobile device, wherein the mobile device is further coupled with a hood device having an excitation filter and an emission filter;
producing a first wavelength of electromagnetic radiation to strike the specimen when light from the LED light source passes through the excitation filter to the specimen;
receiving the fluorescent light emitted from the specimen and converting it to a second wavelength of electromagnetic radiation when it passes through the emissions filter;
capturing the second wavelength of electromagnetic radiation emitted from the specimen using the imaging device coupled with the mobile device; and
detecting the specimen based on the light captured by the imaging device.

2. The method of claim 1, wherein fluorescence of the specimen is excited by a white light LED light source in a flash device built into the mobile device.

3. The method of claim 1, wherein the LED light source and the imaging device are directly powered and controlled by the mobile device.

4. The method of claim 3, wherein the LED light source is separate from the mobile device and is powered and controlled via a wired or wireless connection.

5. The method of claim 1, wherein the emitted fluorescent light is captured directly via an imaging device built into the mobile device or by an imaging device powered and controlled by the mobile device via a wired or wireless connection.

6. The method of claim 1, wherein the hood device is configured to attach to the mobile device and includes two open apertures including:
a first aperture for positioning the excitation filter over the front of the LED light source coupled with the mobile device; and
a second aperture for positioning the emission filter over the front of the lens of the imaging device coupled with the mobile device.

7. The method of claim 1, wherein the hood device is designed to allow users to interchange the excitation and emission filters for use with different fluorophores.

8. The method of claim 7, wherein multiple filters are built into a rotating wheel and that are disposed in a manner such that each filter can be rotated into position to allow different filters to be selected by users.

9. The method of claim 1, wherein the specimen is present in a western blot.

10. The method of claim 1, wherein the specimen is present on a polyvinylidene fluoride (“PVDF”) or nitrocellulose membrane.

11. The method of claim 1, wherein the second wavelength of electromagnetic radiation is in the visible light spectrum, and wherein the method further comprises displaying the captured second wavelength of light on a display of the mobile device for observation by users.

12. The method of claim 1, wherein the second wavelength of electromagnetic radiation is in the infrared light spectrum.

13. The method of claim 1, further comprising providing analysis of the specimen after the light emitted from the specimen has been captured using an application running on the mobile device.

14. The method of claim 1, further comprising controlling the LED light source and the imaging device coupled with the mobile device to substantially simultaneously excite the specimen and capture fluorescent light emitted therefrom using an application running on the mobile device.

15. A system for substantially simultaneously exciting a fluorescently labeled specimen and capturing fluorescent light emitted therefrom using a mobile device, the system comprising:
a light-emitting diode (“LED”) light source coupled with the mobile device to excite the specimen;
an imaging device coupled with the mobile device to capture fluorescent light emitted from the specimen;
a hood adapted to be coupled with the mobile device, the hood including:
(1) an excitation filter configured to produce a first wavelength of electromagnetic radiation to strike the specimen when light from the LED light source passes through it; and
(2) an emission filter configured to receive the light emitted from the specimen and to convert it to a second wavelength of electromagnetic radiation to be captured by the imaging device,
a display screen to display an image of the second wavelength of electromagnetic radiation, wherein the specimen is detected based on the image.

16. The system of claim 15, wherein fluorescence of the specimen is excited by a white light LED light source in a flash device built into the mobile device.

17. The system of claim 15, wherein the LED light source is directly powered and controlled by the mobile device.

18. The system of claim 15, wherein the LED light source is separate from the mobile device and is controlled via a wired or wireless connection.

19. The system of claim 15, wherein the emitted fluorescent light is captured directly via an imaging device built into the mobile device or by an imaging device powered and controlled by the mobile device via a wired or wireless connection.

20. The system of claim 15, wherein the hood is configured to attach to the mobile device and includes two open apertures including:
a first aperture for positioning the excitation filter over the front of the LED light source coupled with the mobile device; and
a second aperture for positioning the emission filter over the front of the lens of the imaging device coupled with the mobile device.

21. The system of claim 15, wherein the hood is further adapted to allow users to interchange the excitation and emission filters for use with different fluorophores.

22. The system of claim 21, wherein multiple filters are built into a rotating wheel and that are disposed in a manner such that each filter can be rotated into position to allow different filters to be selected by users.

23. The system of claim 15, wherein the specimen is present in a western blot.

24. The system of claim 15, wherein the second wavelength of electromagnetic radiation is in the visible light spectrum that can be displayed on a display screen of the mobile device for observation by users.

25. The system of claim 15, wherein the second wavelength of electromagnetic radiation is in the infrared light spectrum.

26. The system of claim 15, wherein the specimen is a fluorescently labeled protein.

27. The system of claim 15, further comprising an application running on the mobile device adapted to control the LED light source and the imaging device coupled with the mobile device to substantially simultaneously excite the fluorescently labeled specimen and capture the light emitted therefrom.

28. An article of manufacture comprising a computer-readable medium having instructions stored thereon adapted to be executed by a computer to cause the computer to perform a process of substantially simultaneously exciting a fluorescently labeled specimen and capturing fluorescent light emitted therefrom using a mobile device, the instructions comprising:
instructions to actuate a light-emitting diode (“LED”) light source coupled with the mobile device to excite the specimen;
instructions to, substantially simultaneously with the actuating of the LED light source, capture fluorescent light emitted from the specimen using an imaging device coupled with the mobile device,
wherein the mobile device is coupled with a hood having an excitation filter and an emission filter disposed thereon, wherein the specimen is excited by a first wavelength of electromagnetic radiation produced by the excitation filter as light from the LED light source passes through it and wherein the fluorescent light captured from the specimen is converted to a second wavelength of electromagnetic radiation when it passes through the emission filter; and
instructions to display an image of the second wavelength of electromagnetic radiation on a display screen of the mobile device.

29. The article of manufacture of claim 28, further comprising instructions to directly power and control the LED light source and the imaging device using the mobile device.

30. The article of manufacture of claim 28, wherein fluorescence of the specimen is excited by a white light LED light source in a flash device built into the mobile device.

31. The article of manufacture of claim 28, wherein the LED light source is separate from the mobile device and is powered and controlled via a wired or wireless connection.

32. The article of manufacture of claim 28, wherein the emitted fluorescent light is captured directly via an imaging device built into the mobile device or by an imaging device powered and controlled by the mobile device via a wired or wireless connection.

33. The article of manufacture of claim 28, wherein the hood device is configured to attach to the mobile device and includes two open apertures including:
a first aperture for positioning the excitation filter over the front of the LED light source coupled with the mobile device; and
a second aperture for positioning the emission filter over the front of the lens of the imaging device coupled with the mobile device.

34. The article of manufacture of claim 28, wherein the specimen is present in a western blot.

35. The article of manufacture of claim 28, further comprising instructions to analyze the specimen after the image has been displayed.
